(19) United States
(12) Patent Application Publication
(10) Pub. No.: US 2012/0284081 A1
(43) Pub. Date: Nov. 8, 2012

(54) Methods and Apparatus for Gathering Intelligence from Itemized Receipts

(76) Inventors: Fang Cheng, Mountain View, CA (US); Edwin Evans, Santa Clara, CA (US)

(21) Appl. No.: 13/447,986

(22) Filed: Apr. 16, 2012

Related U.S. Application Data
(60) Provisional application No. 61/481,532, filed on May 2, 2011.

(51) Int. Cl. G06Q 30/02

(52) U.S. Cl. 705/7.29

(57) ABSTRACT

An intelligence-gathering system operates on a network-connected server having at least one processor and at least one coupled data repository, with software executing on the at least one processor from a non-transitory medium. The software provides a first function obtaining data from itemized receipts, a second function obtaining related data from one or more merchant sites, and a third function matching data sets obtained from the itemized receipts to data sets obtained from the one or more merchant sites.

### CROSS-REFERENCE TO RELATED DOCUMENTS

This application claims priority to Provisional Patent Application 61/481,532, filed on May 2, 2011, and the entire disclosure of that application is incorporated herein at least by reference.

### BACKGROUND OF THE INVENTION

1. Field of the Invention

The present invention is in the field of commerce, including e-commerce and pertains particularly to methods and apparatus for gathering intelligence from itemized receipts, as well as methods for using the gathered intelligence for targeted CRM and marketing.

2. Discussion of the State of the Art

In the field of commerce, including ecommerce, receipts as transaction records typically contain information about the items that are purchased in the associated transactions. Such receipts are termed itemized receipts in the art. Itemized receipts can be printed on paper or delivered in digital formats. Paper receipts can be transformed to digital formats by techniques like scanning, photography, or like methods. Digital receipts are easy to store and manage and are susceptible to automated data extraction and analysis.

In current art, optical character recognition (OCR) techniques can be used to filter out text and numbers from scanned receipts and natural language processing (NLP) techniques can be used to further “understand” the text and numbers lifted from receipts. Numerous challenges exist in understanding the meaning of the text and numbers mined from itemized receipts. Although algorithms have been created for automatically extracting merchant information, dates, and price information directly from itemized receipts, there are currently no automated methods for “understanding” the itemized product information on a receipt or for matching the product/service items listed on the receipt to Universal Product Code (UPC) or other product/service specific data.

The main cause for the lack of more sophisticated approaches to mining itemized receipt data is that the product information (product name, brand, model, etc.) are often abbreviated, misspelled, or otherwise coded or altered to fit the space limitation of an itemized receipt. Another challenge to successful data mining of itemized receipts is that for products and services offered by more than one independent merchant, the description data may vary widely on different receipts from different merchants. Currently there is no consistent model for listing items purchased on an itemized receipt.

Therefore, what is clearly needed in the art are more consistent methods and apparatus for gathering intelligence from itemized receipts. A system incorporating such methods and apparatus could provide better data for marketing and social networking applications. It also allows for applications such as automatic manufacturer rebate/coupon redemption, automatic matching of an itemized receipt to a payment charge on a payment card statement, cross merchant manufacturer offer, cross merchant manufacturer loyalty program, and point/credit mechanism that is based on the purchase of certain product(s) regardless where the purchase is made.

### SUMMARY OF THE INVENTION

The problem stated above is that access to knowledge from transaction records is desirable for a marketing entity, but many of the conventional means for understanding transaction records, such as mining information from itemized receipts, also create uncertainties in the veracity of the data mined. The inventors therefore considered functional elements of a transaction system, looking for elements that exhibit interoperability that could potentially be harnessed to provide intelligence from mining of itemized receipts recorded during transactions but in a manner that would not create misinformation and other uncertainties relative to the veracity of the mined data.

Every transaction system is propelled by customer activity, one by-product of which is an abundance of itemized receipts produced from the transaction recording process. Most such transaction systems employ servers and software to conduct the transactions and to ensure customers have itemized details of their transactions, and servers running software are typically a part of such apparatus.

The present inventor realized in an inventive moment that if, after the point of transaction completion, consistently accurate information could be mined from itemized receipts, significant opportunity for providing services based on the mined data might result. The inventor therefore constructed a unique system for garnering intelligence from mined transaction receipts that allowed more relevant associations to data associated with those transaction data. A significant improvement in the integrity of mined and associated data results, with no impediment to the transaction process created.

Accordingly, in an embodiment of the present invention, an intelligence-gathering system is provided, comprising a network-connected server having at least one processor and at least one coupled data repository, software executing on the at least one processor from a non-transitory medium. The software provides a first function obtaining data from itemized receipts, a second function obtaining related data from one or more merchant and/or third party sites, and a third function matching data sets obtained from the itemized receipts to data sets obtained from the one or more merchant and/or third party sites.

In one embodiment, the network is the Internet network or a connected sub-network. In one embodiment, the itemized receipts are one or a combination of paper receipts and digital receipts. In one embodiment, the first function obtains data by a combination of optical character recognition (OCR) method, and natural language processing (NLP). In another embodiment, the first function obtains data by intercepting digital receipt data from one or more transaction terminals or servers. In another embodiment, the first function obtains data by crawling or collecting itemized receipt data that are already in digital form (e.g. by collecting email digital receipts)

In one embodiment, the one or more merchant sites are websites linked to searchable data repositories. In another embodiment, the one or more sites are websites linked to searchable data repositories aggregated across multiple merchant data repositories. In one embodiment, the second function obtains data by scraping web-based data associated with a web page. In one embodiment, the third function includes logic for scoring the likelihood of a match. In an embodiment wherein merchant sites are websites linked to searchable data repositories, the system further includes a function for limiting or constraining the volume of memory searched. In a preferred embodiment, the data sets obtained from the itemized receipts describe products and or services purchased, and the data sets obtained from the one or more merchant sites describe the same or comparable products and or services.

In another aspect of the invention an intelligence-gathering method is provided, comprising the steps (a) digitally processing data from itemized receipts to produce one or more machine-readable data sets, each data set describing a product and or service purchased; (b) using the one or more data sets produced in step (a) as criteria, searching one or more merchant sites for like data; (c) using the one or more data sets produced in step (a), grading the likelihood of a best match between the data set and returned merchant data; and (d) selecting the merchant data with the highest matching probability as a best match for each data set produced in step (a).

In one aspect of the invention, the method of claim 11 is practiced from a non-transitory medium coupled to a network-connected server. In a variation of this aspect, the network-connected server is an Internet connected server. In one aspect of the method, in step (a), the digital processing includes one or a combination of an optical character recognition (OCR) technique, and a natural language processing (NLP) technique. In one aspect, in step (a), the itemized receipt data is obtained from a transaction terminal or server, or aggregated by crawling or collecting email receipts.

In one aspect of the method, in step (a), the itemized receipt data is obtained from paper receipts and or digital receipts submitted by consumers. In one aspect, in step (b), merchant and/or third party sites are websites linked to searchable data repositories. In one aspect of the method, in step (a), one or more product or service categories is inferred relative to products and services purchased and in step (b), the product or service categories are used as search volume constraints in searching one or more merchant sites. In one aspect, in step (c), a best match for a data set is a percentage value of match, a real number, or symbolic indicia. In one aspect, in step (d), the searchable data is obtained by scraping web-based data associated with a web page.

### BRIEF DESCRIPTION OF THE DRAWING FIGURES

FIG. 1 an architectural overview of an ecommerce network supporting intelligent data mining of itemized receipts according to an embodiment of the present invention.

FIG. 2 is an interaction sequence chart illustrating brokerage of intelligent data mining of itemized receipts.

FIG. 3 is a process flow chart illustrating steps for intelligent data mining of itemized receipts.

FIG. 4 is an entity relationship model illustrating relationships between basic components of a system for gathering intelligence from itemized receipts.

### DETAILED DESCRIPTION

The inventors provide a system for gathering intelligence from itemized receipts that allows data from itemized receipts to be matched with relevant data from one or more merchant sites. The present invention is described in enabling detail using the following examples, which may describe more than one relevant embodiment falling within the scope of the present invention.

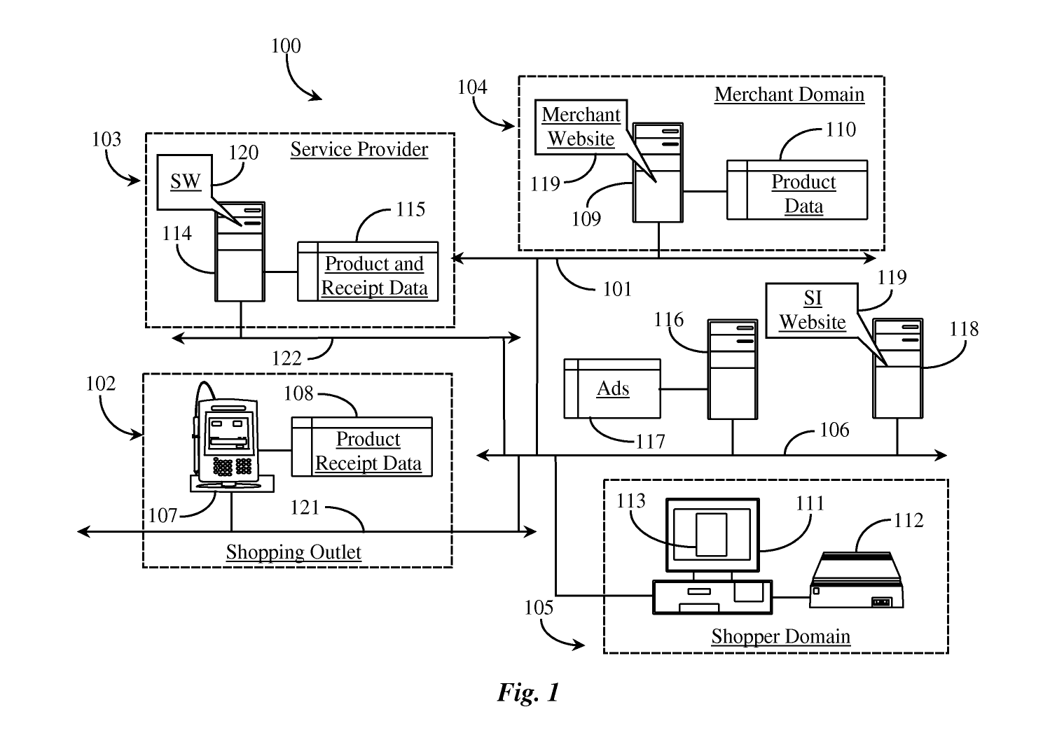

FIG. 1 an architectural overview of an ecommerce network 100 supporting intelligent data mining of itemized receipts according to an embodiment of the present invention. Ecommerce network 100 includes an Internet network represented logically herein by a network backbone 106. In a preferred embodiment, network backbone 106 represents the Internet network including any connected sub-networks such as communications carrier networks. Network backbone 106 may, hereafter, be referred to as Internet backbone 106. Internet backbone 106 includes all of the lines, equipment, and access points that make up the Internet network as a whole. Therefore, there are no geographic limitations to the practice of the present invention.

Ecommerce network 100 includes a number of sub networks connected to Internet backbone 106. A merchant domain 104 is illustrated in this example. Merchant domain 104 includes a local area network (LAN) 101. LAN 101 represents the network connectivity of merchant domain 104 to Internet backbone 106. Ecommerce network 100 includes a shopper domain 105. Shopper domain 105 represents connectivity of a consumer or shopper to Internet backbone 106. Ecommerce network 100 includes a shopping outlet 102. Shopping outlet 102 represents any retail shopping outlet for facility where consumers such as one operating from shopper domain 105. Shopping outlet 121 includes an automated transaction network backbone 121. Backbone 121 represents any digital network that may carry automated transaction terminal (ATT) data from any connected ATT. Ecommerce network includes a service provider domain 103. Service provider 103 represents any company or entity that provides intelligent data mining from itemized receipts as a third-party service.

Merchant domain 104 includes a web server 109. Web server 109 includes a non-transitory digital medium that contains all of the software and data required to enable function as a web server capable of serving web pages and associated data to consumers and other businesses. Server 109 hosts a merchant Website 119. In this example, server 109 is connected to LAN 101, which is in turn connected to Internet backbone 106 for public access. Server 109 may instead be operated by a third-party web hosing service and may have direct connection to backbone 106 without departing from the spirit and scope of the present invention. Merchant Website 119 includes information about the merchant and products and service that are available through the merchant Website and that may be available for purchase at shopping outlet 102.

Merchant 104 represents any number of merchant domains that may have products and services available through a shopping outlet such as outlet 102. Server 109 includes a data repository 110 that contains information about products and or services that the merchant makes available to consumers. In this example, product data includes detailed information about all of the products and services the merchant provides. Merchant Website 119 may include a login page, a registration page, and one or more pages that describe products and services that might be available for purchase at one or a number of shopping outlets such as outlet 102. Such description pages may contain full product/service descriptions, pricing information, information about accessory products, brand name, serial number, model number, physical attributes such as size, dimensions, versions, color, and other technical information. Multiple separate merchants that provide similar products and services that may be in competition with one another to provide such products and services through shopping outlets like outlet 102. Such products and services may also be available through the merchant's Website such as on a shopping page.

Shopping outlet 102 includes a transaction terminal or machine 107. Transaction terminal 107 includes a non-transitory physical medium that contains all of the software and data required to conduct transactions including issuance of electronic and printed receipts that itemize the products and/or services purchased at that terminal. Terminal 107 provides automated recording of all purchases made by shoppers at that terminal. There may be many such terminals or registers within the shopping domain. Transaction network 122 may provide access to payment processing service providers (not illustrated) that facilitate payment processing for purchases made. Transaction terminal 107 has connection to a data repository 108 containing product receipt data in the form of electronic transaction records.

A transaction record is analogous to a digital receipt that itemizes purchases made by each shopper that checks out at that terminal. Such electronic receipts may be printed at the terminal to give shoppers an instant record of purchases made at the shopping outlet. Electronic versions of such receipts may be forwarded in secure manner through email, wireless message, or by other known methods to electronics devices or connected computing appliances operated by consumers. Shopper domain 105 includes an Internet-connected computing appliance 111 having a processor, a display, and apparatus (keyboard, keypad, touch screen) for inputting data. In this example, shopping domain 105 includes an optical character recognition (OCR) scanner 112 for digitizing paper documents including paper receipts representing itemized receipts received by shoppers. In this example a scanned document 113 displayed on computing appliance 111 represents one or more itemized receipts digitized through OCR scanning.

Service provider domain 103 includes a LAN 122 connected to Internet backbone 106. LAN 122 supports a data processing server 114. Server 114 includes a non-transitory physical medium that contains all of the software and data required to enable function as a data processing server. Service provider 103 may also maintain a Website (not illustrated) for service registration and subscription to services. Server 114 hosts software (SW) 120. SW 120 provides intelligent data mining operations on digital receipt data and matching of items identified in the receipt data to merchant data that includes expanded information about the product/service data identified in digital receipt data. Server 114 has connection to a data repository 115 that may contain contains product/service data from merchant Websites or data sources and digital receipt data from itemized transaction records and/or paper receipts. Repository 115 may contain information from repository 108 connected to transaction terminal 107 in shopping outlet 102; information from merchant Website, more particularly from repository 110 connected to web server 109; and information from shopper domain 105 such as digitized receipt data processed by computing appliance 111.

Internet backbone 106 supports a web server 118. Web server 118 includes a non-transitory physical medium that contains all of the software and data required to function as a web server. Web server 118 hosts a social interaction (SI) Website 119. SI 119 may be any type of social interaction network such as Facebook™, Myspace™, or any Website that provides personal Webpages to subscribed consumers. Yahoo™, AOL™, Google™, MSN™, and other such entities may be included in the realm of social interaction sites that may provide some aspect of social interaction for registered consumers. Backbone 106 supports an advertisement server 116. Advertisement server 116 includes a non-transitory physical medium that contains all of the software and data that enables function as an ad server. Ad server 116 has connection to a data repository 117 that contains digital advertisements for ad service.

In one embodiment of the present invention, shoppers such as one operating from shopper domain 105, shop at a retail outlet like outlet 102. Shoppers may collect itemized paper and or digital receipts from shopping activity. The receipts provide some record of transactions completed by the shopper. Paper receipts may be scanned into digital format using scanner 112 connected to computing appliance 111. Receipt 113 represents a digitized version of a paper receipt. In addition to OCR scanning, paper receipts may also be digitized by photographing such receipts using a hand-held smart phone, iPhone, or similar electronic communications device. The digitized receipt data is represented as receipt data 113 displayed on computing appliance 111.

Receipt data typically contains only minimal information that identifies products and services offered through shopping outlet 102. Product identifications may be abbreviated, coded, or otherwise shortened in line item representation on itemized receipts because of limited space of the printed margins of the paper version of the receipt. Minimal information for a receipt item may include item identification, item quantity, and item unit price including rebate or recycle amounts applied to purchase. In some cases, categories are identified on an itemized receipt such as grocery item, gas, tobacco product, hardware, general merchandise, etc. Other information provided on a paper or digital itemized receipt include the name and store number of the shopping outlet, identification of the transaction terminal used to generate the record or purchase, the identification of the operator of the transaction terminal (if applicable), the date and time of purchase, etc.

In many cases, digital records are identical to printed receipts as the receipts are printed from the digital transaction data. Service provider 103 provides intelligent data mining of itemized receipts for the purpose of using the mined information to gather more data relevant to the items and services purchased on the receipt. In this respect, opportunities are opened for provision of specific services that could provide additional intelligence to shoppers, outlets, and merchants regarding the items whose transaction data was mined from the receipt. Intelligence gleaned from mining receipt data can be used to search out other data that may be associated to the products and services rendered and that would not be otherwise available to the consumer solely from the itemized receipt data. The focus of the present invention is to provide additional and relevant information to consumers about products and services that they have purchased. This focus may also be extended to the provision of certain intelligence to individual outlets through which the products and services are bought and to merchants who provide the products and services to market.

In one embodiment of the present invention, a shopper such as one operating from shopping domain 105 may shop at one or more shopping outlets like outlet 102 and may save their itemized receipts in paper form or in digital form. Periodically, the shopper may scan in or take digital pictures of those saved receipts for the purpose of uploading those receipts to service provider 103. SW 120 includes components that enable the receipt data to be processed in order to create isolated base item data sets representing the items and services purchased over time by the shopper. SW 120 contains components that enable the service provider to gather relevant information about those products and services from external data sources. The external data sources may be identified on the receipts in some cases and in other cases inferred through knowledge obtained from the receipts and weighted against general knowledge about the products and services.

For example, the merchant or merchants providing the products and services through the shopping outlet manage data stores that contain additional information related to those products and services that may not be available in the receipt data. Therefore, SW 120 contains components that enable the service provider to obtain related data by proper matching of item information, including merchant identification to the same item information in the identified merchant's data stores. General knowledge may also be available to the service provider regarding competing merchants who are not identified in the receipt data but are known to provide the same similar or products and services to shoppers. The related data gathered through matching information from receipt data to external data sources can provide not only the sponsoring merchant data but also competing merchant data and other outlets through which the products and services might be obtained in the future.

A service such as described above might help the shopper save money on future purchases by associating lower available pricing information and alternative shopping locations discovered from external data sources to each item (product and or service) listed on the uploaded receipt data for that shopper. In this respect, a personalized service for each shopper may be envisioned that helps direct the shopper to better sources for those products and services the shopper buys repeatedly or periodically.

The same information provided as personal service data may assist the retail outlet in pricing policies when correlated against all shoppers evaluated for a period of time. For example, data returned from competing merchants external data sources may indicate that the retail outlet is charging too much for certain products and services or not enough for certain products and services when receipt data is compared to such external information that includes available pricing data. Merchant's can also benefit from information that informs them that certain outlets might be more productive in moving certain products and services than the current outlets contracted to sell such items and services.

SW 120 executing from server 114 may intercept transaction records directly from transaction terminals like terminal 107 in shopping outlet 102. In this scenario, the receipt data is not necessarily individualized to identify shoppers unless the outlet includes shopper registration and shopper identification facilities to track personal shopping records for individual shoppers patronizing the outlet. However, shopping outlets maintained by merchants or under contract by multiple competing merchants may create reports that illustrate certain trends in product and service sales that can aid merchants in product placement and competitive pricing strategies. Personalized receipt data (receipts that identify the shopper) that might be directly intercepted from a shopping terminal can be processed and matched to external data that reveals personal web pages or personal devices maintained by the shopper. In this scenario, targeted advertisements may be directed from a participating advertisement server like server 116 serving ads 117.

In one aspect of the present invention, a service operated by service provider 103 with the aid of SW 120 may be cobranded such that any social interaction Website such as SI Website 119 could provide product, price, and purchase location comparison services for clients having personal pages with the service. In this case, a shopper operating from shopper domain 105 might scan in paper receipts to computing appliance 111 using scanner 112 to produce receipts or receipt data 113. The receipt data for that client may then be uploaded to the shoppers personal profile page or Webpage maintained at the SI site. In such a case, SW 120 may reside on and execute from server 118 or a redirect to server 114 from server 118 may be initiated whenever the client activates a service session.

The service provider, aided by SW 120 may intercept uploaded receipt data from the shoppers personalized Webpage and may process the data and match the data to data obtained from or otherwise accessed from external data sources that have been identified through the receipt data or that were generally known by the service provider to be associated with similar products and services listed as base items on the receipt data. The service provider may then return data summaries, suggestions, or tips on further procurement of those base items that may include quality comparison information, price comparison information, product location information, as well as other data inferred from processing and matching receipt data to data from external sources.

One example of a viable service might be one that takes in all of a shoppers receipt data week by week relative to a particular outlet like a grocery outlet the shopper patronizes regularly. The provider then obtains additional information by matching data from those receipts to data from external sources like merchant sources and other outlets. An accounting might be made relative to the most repetitive purchases or those groceries purchased every week by the shopper at the same outlet. The service may provide a general report that may identify which outlets would be better shopping locations for those groceries (collection of items repeatedly purchased) based on overall pricing comparison, coupon participation, and other data gleaned by matching the information to external data sources.

Such a recommendation can change periodically based on the content of the items purchased from week to week. However, the service can predict overall savings per shopping trip based on the expectation that the same items will again be purchased. GPS or location information and current gas pricing information can be exploited to calculate offset costs of transportation from the shopper's location to a different shopping outlet where the offset can be applied to the overall cost of the weekly shopping trip in terms of the groceries that are repetitively purchased. In this way shopper can realize savings in an evolutionary manner by following weekly tips and recommendations provided by the service. In such a case, the shopper need only upload one receipt that includes all of the items purchased in the weekly or bi-weekly shopping trip. The service performs the analysis of the receipt items and matching of those to external data sources. The service then recommends any shopping outlet for the next trip purchasing the same items and can pre-report the amount of saving the shopper can expect at the recommended outlet or outlets.

In a variation of the above mentioned service, the service provider aided by SW 120 may also perform analysis by categories such as meats, dairy, produce, dry goods, canned goods, etc. and may recommend more than one shopping outlet for purchasing products according to one or more categories. Such intelligence may enable the shopper to consistently save money when grocery shopping, for example, without having to perform any research on their own, which can also cost the shopper precious time and money. This type of service relies on consistent product procurement of the same types and quantities of items on a periodic basis, as is typically the case with weekly or bi-weekly grocery shopping. Outlets and merchants may also benefit from the summary data (cleansed of shopper identity) to plan better product availability, pricing, presentation, advertising, coupon distribution, etc.

The examples cited above involve grocery shopping where the same types of products are purchased regularly. However, the present invention may also be practiced in other areas where repetitive consumption of a same product or service exists. One example might be a painting contractor that regularly purchases painting supplies and equipment. Another example might be a commuter that regularly purchases gasoline at periodic intervals. A business operating a fleet of vehicles might be incensed to provide receipts for fuel and routine maintenance in order to learn of any alternative outlets or providers that might save them money. The service of the present invention may be practiced automatically and may be transparent to the user. A business may not be able to afford a human buyer that would ordinarily research price savings for products and services regularly purchased by that business. Automating the process provides a less expensive way to identify and access savings that may be associated with those regular purchases.

Another service application is to serve loyalty point or cash-back rebates or other loyalty based rewards that are sponsored directly by manufacturers across multiple retailers selling their product. Prior to the present invention, manufactures, such as Consumer Packaged Goods (CPGs) makers, lack the means to capture the sales of their product across the different stores selling their product(s) and lack the means to reach out to the right customers who make the corresponding purchase. The present invention resolves the issue and allows manufacturers like CPGs to directly issue targeted offers or marketing contents to the consumers.

In a variation of the manufacturer sponsored marketing services, the present invention can be used in conjunction with a payment service to allow for manufacturer rebates and/or cash-back to be directly credit to the user payment account. In such service application, the payment type as well as the limited payment card information printed on the receipt can be used to validate and/or select the correct user payment account, to which the credit need to be issued to. The same method can be used by credit card issuers, banks, and cable/cell phone service providers to offer reward mechanism that is triggered by a purchase of certain particular product item. Prior to the present invention, credit card issuers and banks can only grant different rewards based on the category of the merchants where the purchase is made, not the product is bought, because they lack of the understanding of the itemized purchasing information.

The services mentioned above are just a few examples of specific services that might be provided based on itemized receipt data mining and matching mined data to external data sources to gather additional information about the base products and services purchased. SW 120 in the areas of may enable other services . . .

Sales and marketing campaigns.

Advertising campaigns.

Behavioral analysis of shopping patterns.

Product attribute comparison services.

Coupon services.

Billing services.

More detail about the basic components of SW 120 will be presented later in this specification. One with skill in the art of ecommerce will recognize that the ability to garner additional information by utilizing data on itemized receipts provides varied opportunities for consumers, merchants, and retail operators.

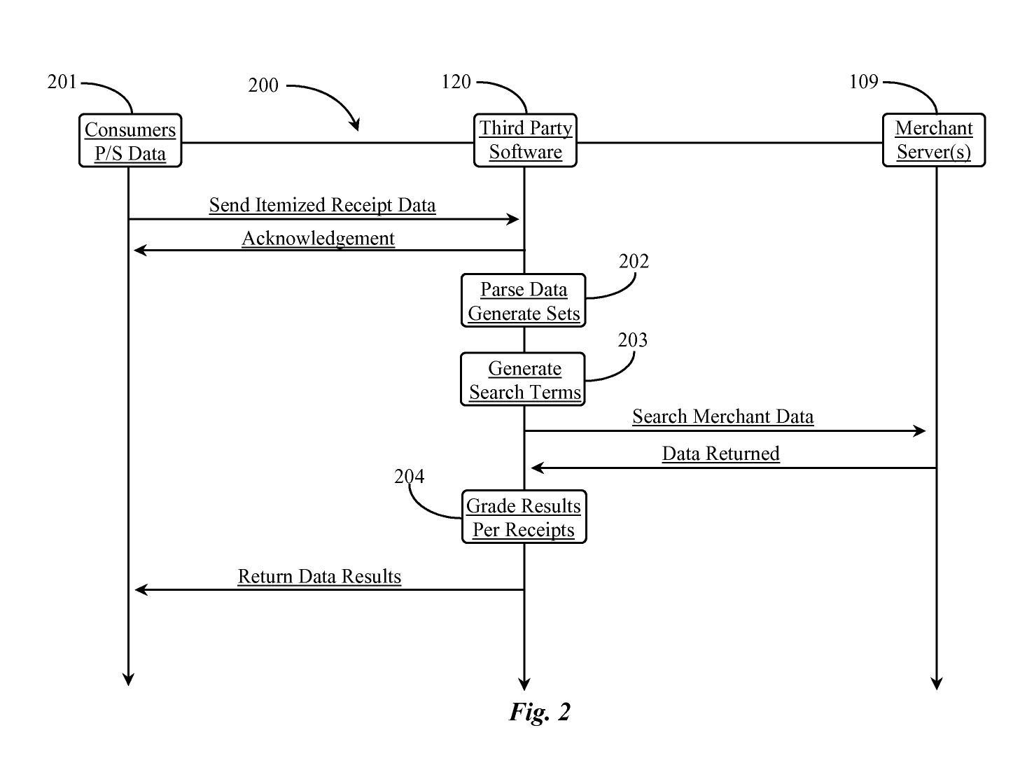

FIG. 2 is an interaction sequence chart 200 illustrating brokerage of intelligent data mining of itemized receipts. Chart 200 includes a cache or repository 201 containing consumer product and service data relative to itemized receipts. The itemized receipt data may be uploaded directly by the consumers themselves or it may be intercepted at transaction terminals at every transaction. In one embodiment the consumer may upload the itemized receipt data to a personalized Website for later access by the service provider. Receipt data may be intercepted at transaction terminals as long as each shopper is identified so that personalized services may be implemented on behalf of those consumers.

Shopper identification may be cleansed from receipt data that is directly intercepted from transaction terminals in cases where the data is used to enhance merchant, advertising, or retail provider functions while protecting the privacy of consumers. However, in some embodiments, direct interception of transaction data in the form of itemized receipts is practiced with inclusion of shopper identifications for the purpose of targeted advertising, analyzing shopper behavior, or other functions that depend on knowledge of who purchased the products and services identified on the itemized receipts.

In this example, software 120 is a third-party software residing on the non-transitory physical medium of a network-connected server. However, SW 120 may also reside on a consumer appliance or on a merchant server without departing from the spirit and scope of the present invention. SW 120 resides in-between the consumer product/service data cache and external data sources such as merchant server(s) 109. SW 120 functions as a broker between consumer data and external data. In a simple embodiment, itemized receipt data is sent from or obtained from a data source containing itemized receipt data of shoppers. The data may be intercepted periodically or in real time from one or more transaction terminals, transaction servers, or periodically from consumer machines or associated web servers.

Itemized receipt data is sent from consumer-centric data source 201 to a server running third-party SW 120. For each data transfer, an acknowledgement and confirmation of data receipt may be returned to consumer-centric data source 201. SW 120 utilizes a parser 202 to parse the itemized receipt data, which may include but may not be limited to shopper ID, date and time of purchase, terminal number, operator ID, retail outlet or department ID, item ID, Item quantity, Item price, discount application, and merchant ID. The parser is adapted to separate the above-mentioned items for use as search criteria to find matching data and associated additional information that might not be available from the receipt data.

The parser or another component such as a search engine 203 generates key words or terms for use in searching external data sources for matching information and additional intelligence that can be gleaned from such matches. In one embodiment a keyword extractor pulls certain keywords or terms from the receipt data that could be used as a search constraint such as categorical terms that may enable limits to how much volume in external data sources is accessed and searched for matching information. SW 120 then searches one or more external data sources for matching information. In a preferred embodiment, receipt data is organized per receipt as “base items” or the products purchased as listed on the receipt. SW 120 looks for the associated “list items” listed or described in merchant data that represents those base items purchased. Additional intelligence for enabling certain services comes from additional data provided by merchants or that is generally known. In one embodiment, data sources that would appear unrelated to the receipt data or merchant data may be accessed where such sources might contain information about the base items not provided by the receipt, the retail outlet, or the merchant.

In one embodiment, merchant data of the merchant associated with the line items in the receipt data is accessed first because of a statistical likelihood that the abbreviations, misspellings, or pseudo codes representing the line items in the receipt data are repeated in the merchant's product page, online catalogue, or other publicly accessible data source. The SW searches merchant server 109 first representing the merchant responsible for providing the products identified on the receipts. A screen scraping SW might be used to access merchant data that is displayed such as on a website. In some cases, items may not be wholly identified just from parsing the receipt data. In these cases, finding matching abbreviations and other matching indicia on the merchant's website may aid in further identification of what the line items are in ling term descriptions.

Data is returned to the server hosting SW 120 as a result of screen scraping or data search operations. All of this activity may be rendered transparent to consumers, retail outlets, and merchants. However, in some embodiments, users may be given permission to monitor processing and may help to correct some search results manually. Once the initial data is found to match receipt data, a matching algorithm 204 may be run locally by SW 120 to optimize matched data to itemized data sets. The algorithm may grade or score search results across all of the receipt items and matching data. During this process, some information may be incorporated and some information may be ignored. In a preferred embodiment, the resulting data results and any additional information ordered per service type are forwarded to the consumer, at least in this example. In other embodiments, depending on the nature of the service, information results may also be shared with retail outlets and merchants. Certain data items may be cleansed from the returned data results in this regard such as shopper identification, etc.

Chart 200 depicts just one sequence of interaction. In some embodiments, additional searches may be performed on different external data sources. Additionally, information that is generally known to the service provider may also be incorporated into returned data results. In a preferred embodiment where the consumer is the subscriber to the information, the service provider may perform auxiliary operations on the data and compare those results with past operations performed on behalf of the consumer. As a result of additional calculations on the data in light of historical data, the service may identify trends in pricing, coupon availability, quality concerns, pricing ranges, future item availability, and other data. Tips and recommendation may be provided to the consumer by the service provider based on ongoing data analysis of the consumers receipt data against the one or more external data sources. The system may, in some embodiments provide predictive analysis regarding price increases, price decreases, product availability, savings potential and the like depending on the nature of the service.

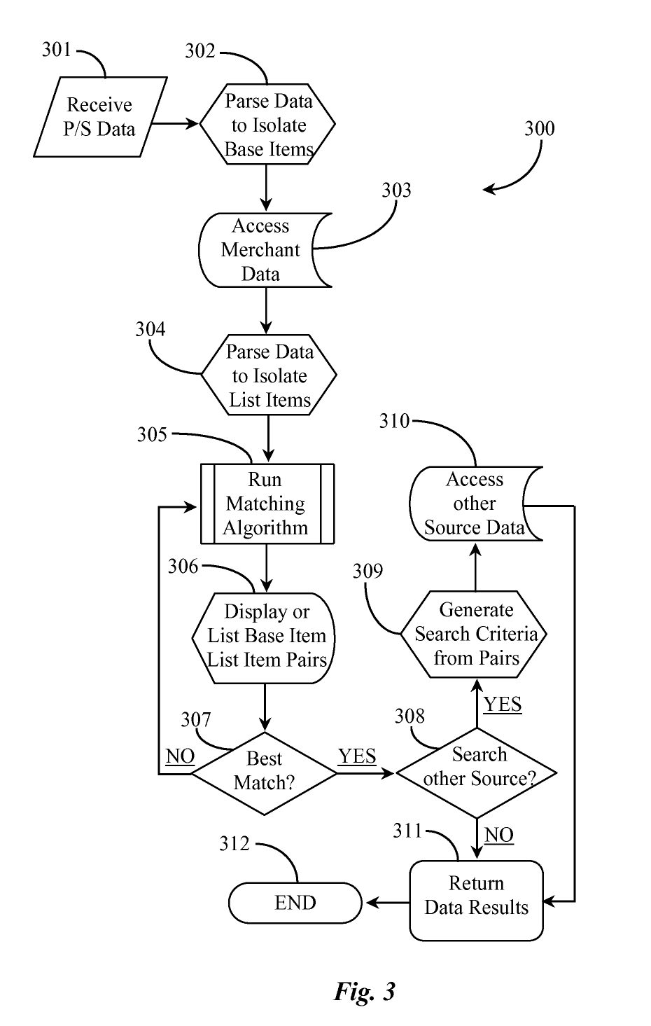

FIG. 3 is a process flow chart 300 illustrating steps for intelligent data mining of itemized receipts. At step 301, the third-party SW receives product and service data representing receipt data submitted by or intercepted on behalf of one or more consumers. In one embodiment where the consumer is the beneficiary of the service, the receipt data submitted or intercepted is separated by consumer identification. In this regard, the receipt data may be tagged with a shopper identification either prior to or after the data is received. For example, if the receipt data comes in from a consumer, a session ID that also identifies the particular consumer may be generated to tag the receipt data under processing for that consumer. In one embodiment convention for tagging or associating consumer identification to receipt data may be provided at the point of transaction so that receipt data may be sorted per consumer. In this variation, a consumer who is not yet subscribing to services offered by the third party could be solicited to join by providing some free initial data results, tips, or recommendations about how to optimize the shopping experience through money savings, time savings, quality management (products), etc.

At step 302, the SW parses the received data to isolate the base items on the receipts. At this stage, some products may be identifiable from the receipt while others are not. For example, if a product is fully spelled out on the receipt, it may be identified as a base item without requiring a data match to determine the identity of the product. However, a product that is described by a misspelled word or an abbreviation may not be identified as a base item until a match is made to a corresponding merchant data set representing the product. The parser used to identify base items on the receipt can be enhanced to consider such things as the area of the receipt holding data so that an item represented as “AB” can be classed as a based item by where (geographically) it resides on the receipt. In some cases product categories are identified on receipts such as produce, hardware, tobacco, gasoline, home and garden, etc. These terms can be used later to limit or constrain the search volume at an external data source such as a merchant site. So an item “CR” under home and garden might be matched to “Crimson Rose” (CR) at the merchant site in the home and garden list of products.

At step 303, the SW accesses merchant data to search for data that matches the data in the base items isolated from the receipt data. SW 120 provides the key terms and any volume search constraints for each base item on the receipt. That is to say that in one aspect, a search may be performed for each base item identified on the receipt. In one embodiment where the merchant data is easily accessed from a website such as by screen scrapping, all of the merchants data may be obtained without using keywords or search terms.

Web scraping is a technique for gathering data using software that makes HTTP requests and parses the resulting HTML to extract the data of interest. Web sites generally display product information or other data using HTML tables or some consistent HTML structure. The format may change over time but this generally only requires minor maintenance to the rules for identifying the data. Some sites require passwords or clicking on buttons or links to get to certain areas of the Website. In this case, the scraping software needs to be more sophisticated and automatically enter data into the username/password edit fields (on Microsoft Windows, this can be achieved by sending WM_SETTEXT messages) and pause while screens are loading. Various techniques can be used to build the rules for identifying the data (such as finding a piece of data based on what it is near) and navigating through the web site (such as conditional rules for where to click depending on the contents of the current page). Often for extracting large amounts of data, it involves clicking on a “Next” button or link and gathering the data one page at a time. In this case the data is cached locally and is searched or matched using keywords, search terms, or like characters appearing both in the bases items and in the cached merchant data. At step 304 where merchant data is processed locally, SW 120 may parse the returned merchant data to isolate listed items in the same way as the base item data sets may be generated at step 302.

In the above embodiment, base items can be directly compared to list items by comparing all of the base item data sets of the receipt to all of the list item data sets returned in the merchant data. This may be performed by a matching algorithm run locally on cached data at step 305. There may be one or more than one matching algorithm used to match base items with listed items without departing from the spirit and scope of the present invention. The use of one algorithm or another depends entirely on the nature of the matching process. At step 306, the SW displays or otherwise presents as results the matched base item/list item pairs. The list item data sets may include much more information than what could be disseminated by consuming the base item data. Such additional information can be leveraged to provide intelligence to the service beneficiary, in this case the consumer.

At step 306, the matched base item list item pairs may be further graded using an algorithm that might confirm best match status. At step 307 if the SW determines that a base/list item pair is not a best match considering all of the available data, then the process may resolve back to step 305 and the same algorithm or another algorithm might be run to further evaluate the matching criteria. In one embodiment two or more algorithms may be selected to run in a hierarchical fashion on the same data set matches to optimize the matching score across multiple criteria. Matching criteria may include item moniker (name, code, abbreviation), price point, version number, size information, color information, model number, serial number, bar code match, etc. It is noted herein however that all of that information may not be available on the receipt. Matching algorithms used to match base (receipt items) and list (merchant descriptions) data sets may be based on a match likelihood model, a statistical model, a rules-based model, or some combination of those without departing from the spirit and scope of the present invention.

If the SW determines that a best match is achieved at step 307, then the system determines at step 308 if any other searches need to be performed to gain additional intelligence about the match. In one embodiment, consideration is given for each matched item in the consumer receipt data. Therefore, in one embodiment, the process may be performed for each base item identified in the receipt data for a consumer, in this case. At step 308, if it is determined that no additional searching is required, the process may skip to step 311 where the data is returned or made available to the consumer. The process may then terminate at step 312 for that consumer.

The data returned may include results computed from or otherwise inferred from the data. These results may include service tips and recommendation regarding the products purchased, the outlets they are purchased from, and the merchants who offer them. Results may include accounting results based on total amounts spent on the items vs. projected amounts that would be spent on the same items at a different retail outlet. The exact nature of tips and recommendations generated depend on the nature of the service for which the process is being performed.

If it is determined at step 308 that one or more additional data sources should be searched, the process may move to step 309 where the SW generates additional search criteria for searching the one or more additional data sources. In one embodiment some of the original keywords and search terms might be reused to search other data sources. At 310, the system may search one or more other data sources for additional information. In the case of a best match, the search may simply focus on getting competing data or additional information not yet obtained about the base-list pair. It is noted herein that incase of a poor match at step 307, one or more other data sources may be accessed to attempt to improve the matching score. In reference to multiple data sources, one example might be multiple merchant sites offering the same base item. In this case, it is possible that screen scrapping might be leveraged to access these data in place of a search engine.

A step may be added to step 310 for correlating and preparing the accessed data for presentation relative to the base/list match data for an item. For example, new data might be incorporated with the base/list data or it may be provided as supplement data or metadata. In any case, the process returns to step 311 and 312 for each consumer whose shopping data was intercepted or submitted for processing. External data sources that might be accessed include merchant websites, merchant data stores and repositories, general data stores, consumer protection data stores, informational websites like Wikipedia™ and even data associated with social interaction Websites or other sources subscribed to by the consumer. For example, a consumer may use the process to determine what other friends that also subscribe to the service in my group have purchased the same or similar items in the past. Social interaction between subscribed family members and friends may arise from the ongoing service. Comments, opinions, and other testimonies from users can provide valuable feedback for merchants, consumers, and retail entities. There are many possible service embodiments that can be realized through practice of the present invention in addition to those already mentioned herein.

In one aspect of the method the methods for grading the likelihood of a match involves using criterions such as price validation (i.e. giving higher grades to matches that has the same price tag on the merchant and/or third-party sites and the price included in the digital receipt data) and language models that grades certain keyword or number match differently from the others based on the prediction power associated with different keywords.

Also in one aspect of the method there can be multiple grading methods being applied and a grade aggregator takes inputs from multiple grading methods to calculate the final grading result.

Still further, in one aspect of the method, after the best match result is presented to the user, an interface if provided to allow the user to curate the result or validate the result, and such human input is automatically used for adjust the grading algorithm so that the grading algorithm can evolve as the correct matches can be recorded in a searchable database for quick look-up in the future and the incorrect matches will also be marked and replaced by correct human input and be stored in a searchable database for quick look-up in the future. In case where multiple grading methods are applied, results from a validation mechanism can be used to “reward” or “punish” one grading methods based on whether it provides the correct answer in a way that the grading methods that provides the correct answer or favors the correct answer will have greater influence on the final grading result.

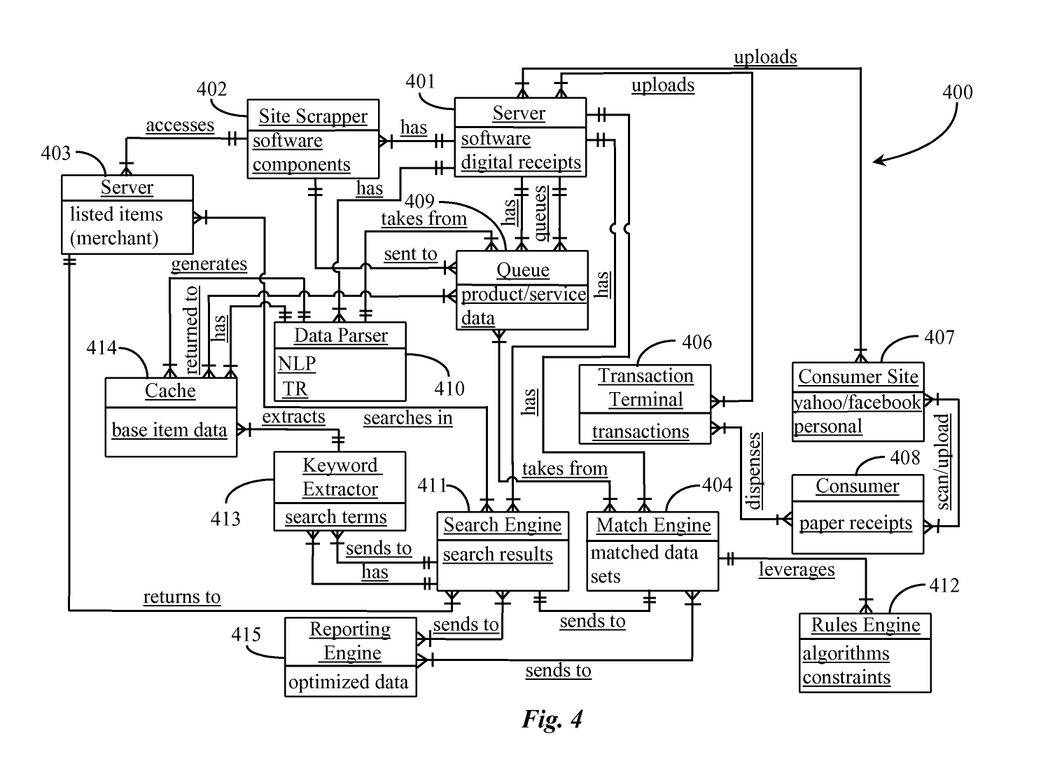

FIG. 4 is an entity relationship model 400 illustrating relationships between basic components of a system for gathering intelligence from itemized receipts. In this example, the SW of the invention resides on and is executed from a server such as server object 401. Server 401 may be a third-party server analogous to server 114 of FIG. 1. Server 401, more particularly SW 120, has access to one or more instances of website screen scrapping software 402. Screen scraping software 402 may be an integral part of SW (120) or may be a separate component that is accessed and leveraged by the SW for accessing merchant data (public data) without the knowledge of permission of the merchant. Server 401, more particularly, SW 120 includes one or more data parsers 410. Parsers 410 may be enhanced for natural language processing (NLP) and text recognition (TR). Server 401 has one or more queues 409. Queue 409 is adapted to receive product/service data in the form of digitized itemized receipts. Server 401, more particularly, SW 120 includes one or more search engines 411 adapted to search in external data sources based on keyword or other data input and return search results. Server 401, more particularly SW 120 has one or more match engines 404 adapted to match base item data from consumer receipts to list item data from publicly accessible merchant sites.

In one embodiment, one or more transaction terminals 406, analogous to terminal 107 of FIG. 1 uploads consumer transactions in the form of digital itemized receipts to one or more servers 401. The number of servers depends on the scale of the system. A very large system may employ multiple servers. In this example, the consumers' identifications are tagged or otherwise associated to their digital receipts. One or more transaction terminals such as terminal 406 may dispense paper receipts to one or more consumers 408 at the time of transaction. In this embodiment, digital receipts may or may not be uploaded directly to server 401 from transaction terminal 406. One or more consumers 408 may instead scan in their paper receipts via OCR scanner or via camera and upload the digitized receipts to one or more consumer sites 407. Consumer sites 407 represent any Webpage with file transfer protocol (FTP) or other media posting capability that accepts uploads of consumer files.

Consumer site 407 may be a Facebook™ profile page, a Yahoo™ personalized page among others, or a personal Webpage that is maintained by the consumer. The one or more consumer sites may periodically upload digitized receipt data to server 401. In this case receipt data may also be tagged according to consumer identification if it is not evident in the receipt data. The two separate methods for obtaining receipt data may be practiced separately or in concert. Server 401 queues the receipt data received into one or more queues 409 for processing. Data parser 410 takes receipt data from one or more queues 409 for further processing. Data parser 410 has one or more cache memories 414 adapted to hold base item data. Parser 410 generates base item data sets in cache memory 414 from receipt data taken from queue 409.

In one embodiment, search engine 411 has one or more keyword extractors 413 for extracting search terms from base item receipt data. In this model, keyword extractor 413 extracts keywords from base item data held in cache 414. The particular keywords extracted may include terms that define product categories that can be leveraged to define a smaller search volume for the search engine to look through for matching data. However, a search engine is not specifically required in order to practice the present invention. In some cases screen scrapping is sufficient to return merchant data for matching against receipt data. In other cases where a match is poor, or additional information is required to satisfy expected service results, search engine 411 may be deployed on one or more occasions during the process.

In this example, the base item receipt data represents organized or sorted data for each identified base item in the receipt data. In a preferred embodiment for consumer services, base item data are separated item by item and associated to the consumer receipt or receipts from which they were parsed. Base item data from one or more cache memories may be returned to one or more queues 409 for further processing. Server 401 may use site scrapper 402 to access one or more severs 403 representing merchant sites and or external data sources to gather data from the publicly accessible pages like product information pages or catalogs. In this case, the site scrapper gathers list data from one or more merchant sites and returns the data to one or more queues 409 for further processing. With both consumer and merchant data in queue, one or more matching engines 404 take receipt data and merchant data (product/service data sets) from queue to perform algorithm-driven data matching services. This process matches receipt items sourced from consumer transactions to corresponding list items sourced from posted or listed merchant product descriptions.

Matching engine 404 leverages one or more rules engines 412 providing access to algorithms and constraints. If processing is complete and the intelligence gathered from the receipts and merchant sites is sufficient for the type of service rendered, then the matching engine may send the optimized matched data sets to one or more reporting engines 415. Reporting engine 415 may formulate data summaries, tips, recommendations or other information for reporting back to consumers, merchants, and retail entities. In this case, a search engine may not be deployed. If it is decided that further information should be gathered, matching engine 404 may send optimized data sets to one or more search engines 411. Search engine 401 may utilize the optimized data and any extracted keywords associated with the data to search in additional servers 403 representing other data sources such as merchant databases, general databases, or other data sources. Search results are returned to one or more search engines 411 from server 403. Search engine 411 may send returned results to match engine 404 for further matching. Search engine 411 may instead send the results along with the optimized data to reporting engine 415 for reporting purposes.

The model for calculating a match score can be parametric or non-parametric. The calculated match score can be a real number such as a likelihood value, a percentage value, a probability value, or a discrete value like true or false. The model can be trained on a set of real receipts and real matching product items listed on the same merchant site or across multiple merchants. The training set can be constructed manually or be directly downloaded through business database for example, a merchant's point of sale (POS) system.

A training process can start with a base model that specifies string matching rules and mismatch penalties and the mismatch penalty (or matching points) can be character-based or string-based. The training algorithm can be based on optimization algorithms with an objective function and a conversion criterion, or can be direct application of simple statistical measures on the training data set. Matching algorithms can also be hierarchical. More specifically, rather than calculating a match score for each base item—listing item pair, the match algorithm can locate certain keywords using a keyword extraction technique that indicates the association of a product item with one or multiple product categories with high likelihood or confidence level. In this way, the search for best a match can be limited to listing items within the associated categories first. Only when satisfactory matches cannot be found within the associated categories, the match can be conducted for listing items within the unassociated categories.

When applied well, a hierarchical algorithmic process can significantly improve the computational speed of the product matching method, so that it enhances the overall performance of the system. This is especially relevant when the method is used in real-time settings. Mechanisms for manually correcting a false match can be built into the system for presenting the matching results and a correction can be remembered by the match algorithm or integrated into the match model. In one embodiment for matching items on a receipt with detailed product descriptions, a customer feedback mechanism can be provided so that the customer can curate false matching results when the identified detailed product description is presented to the customer. The correction can be enforced on the same item from the same merchant.

It is noted herein that universal resource location (URL) information including universal resource identification (URI) data may be gathered using screen scrapping techniques and or appended to base item data sets from general knowledge, address registers, or other local sources. It is also noted herein that the process may vary slightly according to the service beneficiary (consumer, merchant, retail entity).

It will be apparent to one with skill in the art that the intelligence gathering system of the invention may be provided using some or all of the mentioned features and components without departing from the spirit and scope of the present invention. It will also be apparent to the skilled artisan that the embodiments described above are specific examples of a single broader invention that may have greater scope than any of the singular descriptions taught. There may be many alterations made in the descriptions without departing from the spirit and scope of the present invention.

What is claimed is:

1. An intelligence-gathering system comprising:
a network-connected server having at least one processor and at least one coupled data repository;
software executing on the at least one processor from a non-transitory medium, the software providing:
a first function obtaining data from itemized receipts;
a second function obtaining related data from one or more merchant or third-party sites; and
a third function matching data sets obtained from the itemized receipts to data sets obtained from the one or more merchant or third-party sites.

2. The system of claim 1, wherein the network is the Internet network or a connected sub-network.

3. The system of claim 1, wherein the itemized receipts are one or a combination of paper receipts and digital receipts.

4. The system of claim 1, wherein the first function obtains data by a combination of optical character recognition (OCR) method, and natural language processing (NLP).

5. The system of claim 1, wherein the first function obtains data by intercepting digital receipt data from one or more transaction terminals or servers.

6. The system of claim 1, wherein the one or more merchant sites are websites linked to searchable data repositories.

7. The system of claim 1, wherein the second function obtains data by scraping web-based data associated with a web page.

8. The system of claim 1, wherein the third function includes logic for scoring the likelihood of a match.

9. The system of claim 6, further including a function for limiting or constraining the volume of memory searched.

10. The system of claim 1, wherein the data sets obtained from the itemized receipts describe products and or services purchased, and the data sets obtained from the one or more merchant sites describe the same or comparable products and or services.

11. An intelligence-gathering method, comprising the steps:
(a) digitally processing data from itemized receipts to produce one or more machine-readable data sets, each data set describing a product and or service purchased;
(b) using the one or more data sets produced in step (a) as criteria, searching one or more merchant or third-party sites for like data;
(c) using the one or more data sets produced in step (a), grading the likelihood of a best match between the data set and returned data; and
(d) selecting the data with the highest matching probability as a best match for each data set produced in step (a).

12. The method of claim 11 practiced from a non-transitory medium coupled to a network-connected server.

13. The method of claim 12, wherein the network-connected server is an Internet connected server.

14. The method of claim 11, wherein in step (a), the digital processing includes one or a combination of an optical character recognition (OCR) technique, and a natural language processing (NLP) technique.

15. The method of claim 11, wherein in step (a), the itemized receipt data is obtained from a transaction terminal or server.

16. The method of claim 11, wherein in step (a), the itemized receipt data is obtained from paper receipts and or digital receipts submitted by consumers.

17. The method of claim 11, wherein in step (b), merchant sites are websites linked to searchable data repositories.

18. The method of claim 11, wherein in step (a), one or more product or service categories is inferred relative to products and services purchased and in step (b), the product or service categories are used as search volume constraints in searching one or more merchant sites.

19. The method of claim 11, wherein in step (c), a best match for a data set is a percentage value of match, a real number, or symbolic indicia.

20. The method of claim 11, wherein in step (d), the searchable data is obtained by scraping web-based data associated with a web page.
